(19) United States
(12) Patent Application Publication
(10) Pub. No.: US 2016/0001619 A1
(43) Pub. Date: Jan. 7, 2016

(54) TIRE COMPRISED OF RUBBER TREAD INTERLOCKED WITH POLYURETHANE CARCASS

(71) Applicant: The Goodyear Tire & Rubber Company, Akron, OH (US)

(72) Inventors: Arindam Mazumdar, Stow, OH (US); Joseph Carmine Lettieri, Hudson, OH (US)

(21) Appl. No.: 14/322,125

(22) Filed: Jul. 2, 2014

(51) Int. Cl. B60C 99/00; B29D 30/06; B60C 9/02; B29D 30/00; B60C 1/00; B60C 11/00

(52) U.S. Cl. CPC B60C 99/00; B60C 1/0041; B60C 11/00; B60C 9/02; B29D 30/0005; B29D 30/06; B29D 2030/0011; B29K 2075/00

(57) ABSTRACT

This invention relates to a vehicular tire having a rubber tread interlocked with a polyurethane carcass.

### FIELD OF THE INVENTION

This invention relates to a vehicular tire having a rubber tread interlocked with a polyurethane carcass.

### BACKGROUND OF THE INVENTION

Vehicular tires are typically toroidally shaped rubber tires which include circumferential rubber tread intended to ground-contacting.

In one aspect, tires have been proposed as being comprised of a cured rubber tread containing interlockable cavities which are mechano-chemically interlocked with a rubber cushion layer which, in turn, is applied to a tire carcass to form a tire assembly and the assembly cured to form a tire. For example, see U.S. Patent Application Publication No. 2012/0186725.

In another aspect, tires have been proposed comprised of a polyurethane carcass bonded to a cured rubber tread. For example, and not intended to limiting, see U.S. Pat. No. 4,669,517.

For this invention it is proposed to evaluate providing a tire comprised of a rubber tread which contains cavities on its inner surface to which a polyurethane carcass is mechanically interlocked which may optionally also be chemically interlocked in a sense of being mechano-chemically interlocked with the rubber tread. By chemically interlocking it is envisioned that the polyurethane reaction mixture chemically interacts with the cured rubber surface.

In the description of this invention, terms such as “compounded rubber”, “rubber compound” and “compound”, if used herein, refer to rubber compositions containing of at least one elastomer blended with various ingredients, including curatives such as sulfur and cure accelerators. The terms “elastomer” and “rubber” may be used herein interchangeably unless otherwise indicated. It is believed that such terms are well known to those having skill in such art.

The polyurethane reaction mixture for formation of the polyurethane tire carcass may, for example, as desired and appropriate, be comprised of a combination of polymeric polyol and polyisocanate or may be a pre-polymer comprised of a reaction product of polymeric polyol and isocyanate which also contains a diamine curative or hydroxyl terminated curative. Such polymeric polyol may be, as desired and appropriate, a polyester or polyether hydroxyl terminated polyol. Sometimes the polyurethane reaction mixture may be referred to as being a cold cast or hot cast polyurethane. By the term cold cast, it is usually meant that the polyurethane reaction mixture is cast into a mold or onto a substrate at or near room temperature (for example, at about or near 23° C.). By the term hot cast, it is usually meant that the polyurethane reaction mixture is cast into a mold or onto a substrate which has been or is to be heated to an elevated temperature. The terms cold cast and hot cast are well known to those having polyurethane experience.

### SUMMARY AND PRACTICE OF THE INVENTION

A tire is provided comprised of a circumferential rubber tread interlocked with a polyurethane carcass.

In one embodiment, a tire is provided comprised of an annular cured rubber tread and a toroidal polyurethane carcass supporting and interlocked with the cured rubber tread, where the cured rubber tread is configured with open cavities in its radially inner surface and where portions of the toroidal polyurethane carcass protrude into and occupy the open cavities in said rubber tread surface to thereby mechanically and/or mechano-chemically interlock the polyurethane carcass to the rubber tread.

In one embodiment, such tire is provided with a circumferential rubber tread interlocked with and adhered to a polyurethane carcass with at least one of primer and adhesive layer, including adhesive over primer layers, applied to the cured rubber tread and thereby positioned between the rubber tread, including the rubber cavities, and polyurethane carcass to enhance the interfacial adhesion. Various primers and adhesives may be used, particularly polyurethane-to-elastomer bonding adhesives, as may be desired and appropriate.

In this manner, then, the surface of the cured rubber tread, including the surfaces of its cavities, contain a coating of at least one of polyurethane-to-elastomer primer or adhesive, or adhesive over primer coatings to promote interfacial adhesion between the cured rubber tread surfaces and the polyurethane carcass, including the open cavities in the cured rubber tire tread into which the polyurethane carcass intrudes and to thereby promote a mechanical or mechano-chemical bonding of the polyurethane carcass to the cured rubber tread.

In further accordance with this invention a method of preparing a tire comprised of a toroidal polyurethane carcass supporting and interlocked with a circumferential cured rubber tread comprises:

(A) Inserting a cured annular rubber tread into a toroidal tire mold cavity with the radially outer surface of the cured rubber tread positioned against an internal (peripheral) surface of the tire mold cavity where cured rubber tread contains a plurality of open cavities in its radially inner surface;

(B) Introducing a liquid polyurethane reaction mixture into the tire mold cavity to fill the tire mold cavity and open cavities of the annular cured rubber tread and thereafter allowing the polyurethane reaction mixture to react and form a solid toroidal polyurethane tire carcass interlocked with the open cavities of the cured rubber tread.

In one embodiment, where appropriate, the polyurethane reaction mixture may be cold cast into the mold cavity.

In one embodiment, where appropriate, the polyurethane reaction mixture may be hot cast into the mold cavity in a sense, for example, that the mold is heated to an elevated temperature to promote curing of the polyurethane in the mold.

In one embodiment, by the polyurethane carcass being interlocked with the open cavities of the cured rubber tread it is meant that the tire tread cavities are shaped to serve to mechanically lock the polyurethane carcass within the open tread cavities themselves. In another embodiment, the polyurethane carcass may be a combination of mechanical and chemical interlocking (e.g. mechano-chemical interlocked) with the rubber tread.

In one embodiment, said method includes application of a coating of at least one of polyurethane-to-elastomer primer or adhesive or adhesive over primer coatings prior to application of said polyurethane reaction mixture.

Therefore, in one embodiment, by use of the adhesive and/or primer on the surface of the cavities in the cured rubber tread, the polyurethane tire carcass may be considered as being mechano-chemically interlocked with the rubber tread.

It is appreciated that the open cavities for the surface of the cured rubber tread may by composed of various configurations such as, for example and not intended to be limiting, trapezoidal, prismatic including truncated prismatic, cubical, polygonal, semi-hemispherical and various rectangular configurations, as well as open grooves which may be directionally oriented (e.g. oriented in a circumferential, or longitudinal, direction of rotation of the tire on an associated vehicle) or randomly oriented. A wide range of open cavity configurations may be used as desired and appropriate depending somewhat upon a degree of interlockability desired.

In one embodiment, in order to promote load bearing properties of the polyurethane carcass, the polyurethane carcass may contain internal load bearing support. Such support may be, for example and not intended to be limiting, in a form of belts (e.g. circumferential belt) contained in the cured rubber tread and/or in the polyurethane carcass as well as an interwoven wire spring structure contained within the polyurethane of the polyurethane carcass which extends around the entire circumference of the polyurethane carcass of the tire and which is coated by and contained within the polyurethane carcass. In one embodiment, the circumferential belt contained in the cured rubber tread may be comprised of at least one woven belt (for example, a fabric woven belt) and the circumferential belt contained in the polyurethane carcass may be comprised of at least one woven belt (for example a fabric woven belt) or comprised of at least one wire spring structured belt. For an example of use of an interwoven wire spring structure as a tire load bearing contributor for the polyurethane carcass, reference may be made to the following U.S. patents and patent application which are incorporated herein in their entirety: U.S. Pat. Nos. 8,141,606, 8,662,122 and 8,720,504 and U.S. Patent Publication No. 2004/0110028.

In practice, rubber products, including rubber treads for tires such as for example treads to be used for retreading of tires, are produced by curing the rubber product at an elevated temperature and pressure in a suitable contoured mold where the uncured rubber and/or mold surface is first provided with a release agent coating, such as for example a polysiloxane product, to promote an efficient release of the cured rubber product from the contoured mold without damaging the rubber product itself.

It is also recognized that, over time, various ingredients contained in the cured rubber, such as for example various process oils, may tend to migrate to rubber surface.

To provide the aforesaid interlocking of the polyurethane carcass to the cured rubber tread, it may be necessary or desirable to remove the mold release coating from the cured rubber tread, as well as ingredients such as, for example, surface oils to which the polyurethane reaction mixture is to be applied and cured, as well as a chemical adhesive coating.

Various means may be used to provide a clean cured rubber surface of the cured rubber tire tread prior to application of the polyurethane reaction mixture to form the supporting polyurethane tire carcass such as, for example, organic solvent cleaning of or by abrading away (e.g. grinding away) of a portion of the cured rubber surface and by activating the rubber surface by laser or plasma treatment of the cured rubber surface to chemically activate the rubber surface for reaction with the polyurethane. As previously indicated an adhesive may be applied to the cured tread surface. In one aspect, where appropriate, a suitable adhesive may be applied to a cured tire tread surface and associated open cavities which contain a silicone based release agent in a manner that the release agent might not need to be removed.

In one embodiment, as previously indicated and as may be desired and appropriate, the liquid polyurethane reaction mixture may, for example, be comprised of a polymeric polyol (e.g. hydroxyl terminated polymeric polyol) and polyisocyanate.

In one embodiment, as previously indicated and as may be desired and appropriate, the liquid polyurethane reaction may, for example, be comprised of a prepolymer of a polymeric polyol (e.g. hydroxyl terminated polyol) and polyisocyanate combined with a diamine curative or hydroxyl terminated curative.

The polyurethane mixture may also contain particulate reinforcement to aid in reinforcing the resultant polyurethane such as, for example and not indented to be limiting, one or more of carbon black, clay, silica, volcanic ash and cellulose fillers might be used where desired and appropriate.

The hydroxyl terminated polymeric polyols (saturated or unsaturated, where desired and appropriate) may, for example, have a number average molecular weight in a range of from about 1000 to about 4000, alternately in a range of from 2000 to about 4000, and may have an hydroxyl functionality in a range of from about 2 to about 3.

Such polymeric polyol may be comprised of, for example, at least one of polyether polyol and polyester polyol typically having an hydroxyl functionality of from about 2 to about 3.

The ratio of isocyanate groups of said polyisocyanate to hydroxyl groups of said polymeric polyol may, for example, be in a range of from about 0.8/1 to about 2/1, although usually the isocyanate is provided in molar excess of hydroxyl groups of the polymeric polyol.

A polymeric polyester polyol may, for example and as hereinafter discussed, be a product of dicarboxylic acid having from about 4 to about 10 carbon atoms and hydroxyl terminated hydrocarbon diols having from 2 to 8 carbon atoms as a condensation product of glycols with an organic polycarboxylic acid or anhydride,

A polymeric polyether polyol may, for example, have a hydroxyl functionality of about 2 to about 3 and may, as hereinafter discussed, be a polymer product of at least one of alkylene oxides and alkylene glycols.

Representative of various diamine curatives for a prepolymer of polyether and/or polyester polyol and isocyanate may be used as desired and appropriate, for example and not intended to be limiting, at least one of methylene dianiline (e.g. 4,4-methylene dianiline) sodium chloride complex, 3,5-dimethylthio-2,4-toluenediamine and trimethylene glycol di-p-aminobenzoate.

Representative examples of various hydroxyl terminated curatives, particularly diols, which may also be considered for chain extenders, are for example and not intended to be limiting, ethylene glycol, 1,4-butane diol, 1,6-hexane diol, cyclohexane dimethanol and hydroquinone bis(2-hydroxyethyl) ether.

Representative examples of the aforesaid polyester polyols may be, for example, condensation products of low molecular weight polyols with an organic polycarboxylic acid or anhydride. Representative low molecular weight polyols for the preparation of the polyester polyols are, for example, glycols such as ethylene glycol, propylene glycol, butylene glycol, pentylene glycol, decamethylene glycol, etc. Representative examples of the organic dicarboxylic acids that can be used are succinic acid, glutaric acid, adipic acid, phthalic acid, terephthalic acid, isophthalic acid, suberic acid, sebacic acid, pimelic acid, and azelaic acid. The anhydrides of such acids can be used in place of the acid. If desired, from about one to 20 percent by weight of a triol or higher polyfunctional polyol or polyfunctional acid can be present to produce branching in the polyurethane polymer.

The aforesaid polyether polyols may be prepared, for example, by polymerizing or copolymerizing alkylene oxides such as ethylene oxide, propylene oxide, and butylene oxides, by polymerizing or copolymerizing the low molecular weight glycols, or by the reaction of one or more such alkylene oxides with the glycols or with triol, or with a polycarboxylic acid such as phthalic acid. The polyether polyols include polyalkylene-aryl ether glycols or triols, polytetramethylene ether glycols, polyalkylene ether-thioether glycols or triols and alkyd resins. Generally the polytetramethylene ether glycols are the preferred polyether glycols.

It is usually desired that the hydroxyl-terminated polymeric polyol is provided as a liquid so that, in some circumstances it may be necessary to pre-heat the polymeric polyol.

The organic polyisocyanates may include various organic diisocyanates and mixtures thereof. The organic polyisocyanates may be, for example, aromatic, aliphatic or cycloaliphatic or combinations of these types.

Representative of such polyisocyanates may be, for example, the toluene diisocyanates, m-phenylene diisocyanate, 4-chloro-1,3-phenylene diisocyanate, 4,4′-tetramethylene diisocyanate, 1,6-hexamethylene diisocyanate, 1,10-decamethylene diisocyanate, 1,4-cyclohexylene diisocyanate, 4,4′-methylene-bis(cyclohexylisocyanate) and 1,5-tetrahydronaphthalene diisocyanate, and mixtures of such diisocyanates. For the purpose of the present invention, one or more of the toluene-diisocyanates, diphenylmethane-4,4′-diisocyanate, 3,3′-dimethyl-4,4′-bis phenylene diisocyanate and 4,4′-methylene bis(cyclohexyl isocyanate) are desired. For convenience, these diisocyanates are referred to as TDI, MDI, TODI and Hie MDI, respectively.

In the practice of this invention it is desirable to provide polyurethane reaction mixture in the absence of solvents. If a solvent should be desired, various nonreactive solvents known to those skilled in the polyurethane art can be used for the preparation of the polyurethane reaction mixtures. Representative of the solvents may be, for example, aromatic solvents such as benzene, xylene and toluene; and the liquid lower ketones such as acetone, methyl ethyl ketone, methyl isobutyl ketone, and diisobutyl ketone. If the polyurethane reaction mixtures are to be used to prepare the cured polyurethanes in confined areas which are subject to explosive hazards, nonflammable chlorinated solvents can be used to form nonflammable polyurethane reaction mixtures. Mixtures of solvents may also be used to obtain satisfactory spreading properties and evaporation rates when the polyurethane composition is applied to an appropriate surface.

### BRIEF DESCRIPTION OF DRAWINGS

A brief description of accompanying drawings is provided to further understand the invention.

FIGS. 1, 2, 3, 4, 5 and 6 (FIGS. 1, 2, 3, 4, 5 and 6) are provided to illustrate various configurations of a cured rubber tire tread interlocked with a polyurethane carcass.

FIGS. 7 and 8 (FIGS. 7 and 8) are provided to illustrate a cross section of an annular cured rubber tread inserted into a tire mold cavity to which a liquid polyurethane is injected, or cast, into the mold cavity to cure to form a tire carcass which is mechanically or mechano-chemically interlocked with the cured tire tread.

### THE DRAWINGS

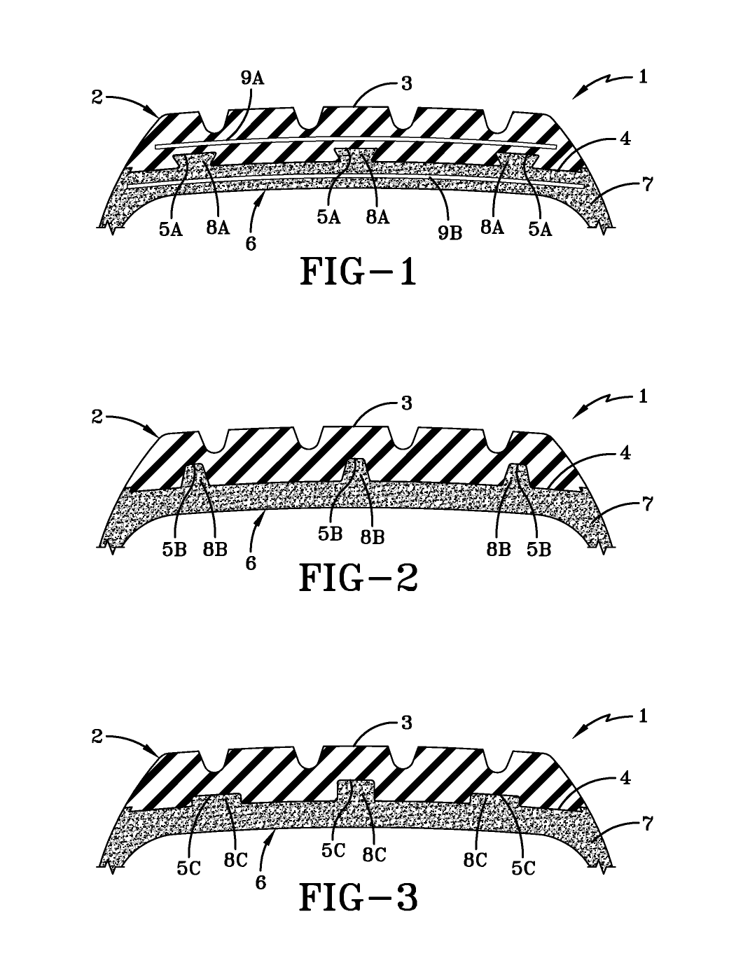

FIG. 1 is a cross sectional view of a portion of a tire (1) with cured rubber tread (3) having a radially outer surface (2) composed of lugs and grooves for ground contacting purposes and a radially inner surface (4) containing a plurality of open cavities (5A) in a form of depressions of a substantially trapezoidal configuration with a polyurethane carcass (6) containing sidewall (7) where the polyurethane carcass (6) interlocked with the cured rubber tread (3) by an intrusion of portions (8A) of the polyurethane carcass (6) extending into and taking the shape of tread cavities (5A) to thereby interlock the polyurethane carcass (6) with said cured rubber tread (3).

It is seen from FIG. 1 that the circumferential rubber tread (3) inherently provides protrusions of the rubber tread (not numbered) into the polyurethane carcass (6) where the rubber tread protrusions are the portions of the rubber tread (3) located between its cavities (5A).

In an alternative embodiment, the tire (1) contains at least one of a circumferential belt (9A), usually at least one and thereby usually a plurality of belts, embedded within the rubber tread (3) for which the belt ((A) may be comprised of a woven belt, and a circumferential belt (9B) usually at least one and thereby usually a plurality of belts embedded within the polyurethane carcass (6) for which the belt (9B) may be comprised of, for example, a fabric belt or a wire spring structured belt.

FIG. 2 is a cross sectional view of a portion of a tire (1) with cured rubber tread (3) having a radially outer surface (2) composed of lugs and grooves for ground contacting purposes and a radially inner surface (4) containing a plurality of open cavities (5B) in a form of depressions of a substantially truncated trapezoidal configuration with a polyurethane carcass (6) containing sidewall (7) where the polyurethane carcass (6) interlocked with the cured rubber tread (3) by an intrusion of portions (8B) of the polyurethane carcass (6) extending into and taking the shape of tread cavities (5B) to thereby interlock the polyurethane carcass (6) with said cured rubber tread (3).

FIG. 3 is a cross sectional view of a portion of a tire (1) with cured rubber tread (3) having a radially outer surface (2) composed of lugs and grooves for ground contacting purposes and a radially inner surface (4) containing a plurality of open cavities (5C) in a form of depressions of a substantially rectangular configurations of varied dimensions of widths and depths with a polyurethane carcass (6) containing sidewall (7) where the polyurethane carcass (6) interlocked with the cured rubber tread (3) by an intrusion of portions (8C) of the polyurethane carcass (6) extending into and taking the shape of tread cavities (5C) to thereby interlock the polyurethane carcass (6) with said cured rubber tread (3).

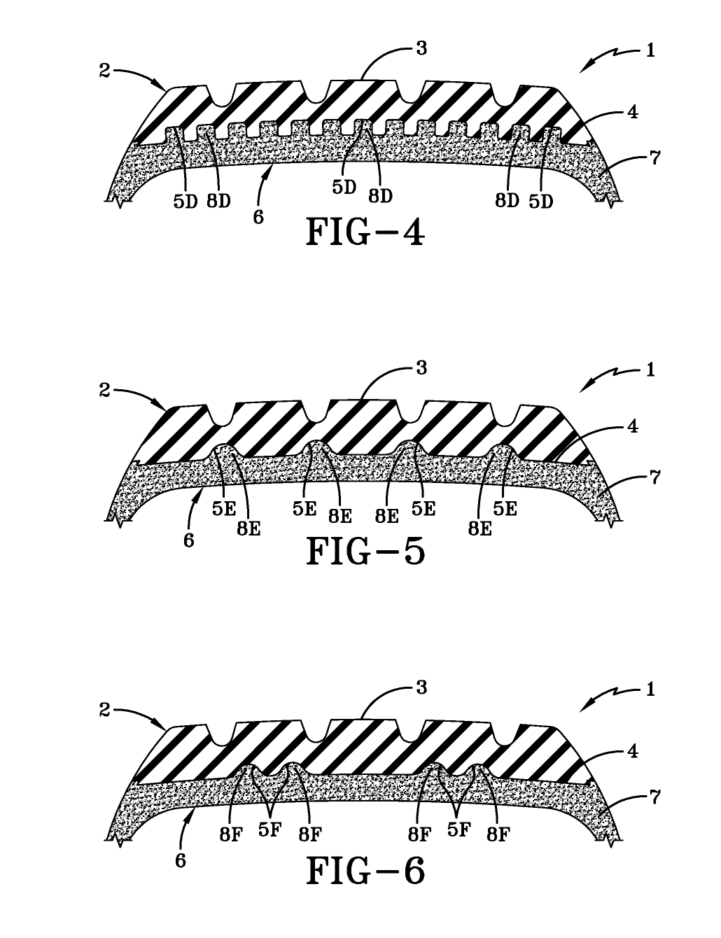

FIG. 4 is a cross sectional view of a portion of a tire (1) with cured rubber tread (3) having a radially outer surface (2) composed of lugs and grooves for ground contacting purposes and a radially inner surface (4) containing a plurality of open cavities (5D) in a form of depressions of substantially rectangular configurations with a polyurethane carcass (6) containing sidewall (7) where the polyurethane carcass (6) interlocked with the cured rubber tread (3) by an intrusion of portions (8D) of the polyurethane carcass (6) extending into and taking the shape of tread cavities (5D) to thereby interlock the polyurethane carcass (6) with said cured rubber tread (3).

FIG. 5 is a cross sectional view of a portion of a tire (1) with cured rubber tread (3) having a radially outer surface (2) composed of lugs and grooves for ground contacting purposes and a radially inner surface (4) containing a plurality of open cavities (5E) in a form of depressions of open semi hemispherical configurations with a polyurethane carcass (6) containing sidewall (7) where the polyurethane carcass (6) interlocked with the cured rubber tread (3) by an intrusion of portions (8E) of the polyurethane carcass (6) extending into and taking the shape of tread cavities (5E) to thereby interlock the polyurethane carcass (6) with said cured rubber tread (3).

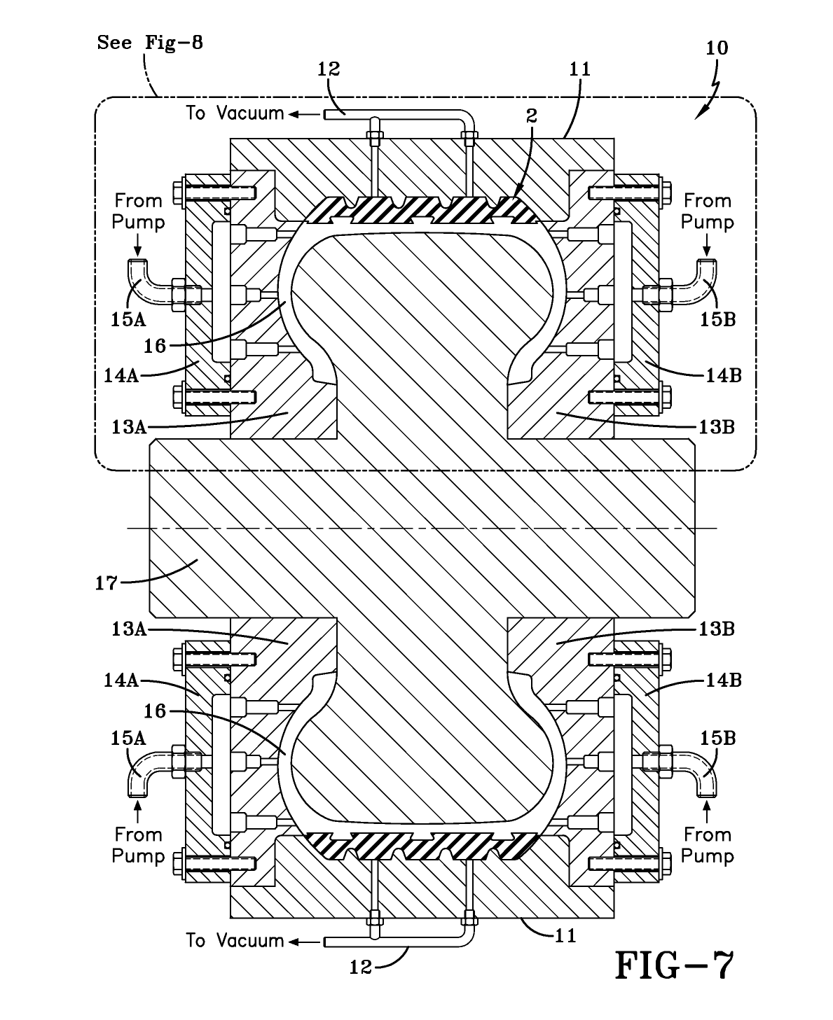

FIG. 6 is a cross sectional view of a portion of a tire (1) with cured rubber tread (3) having a radially outer surface (2) composed of lugs and grooves for ground contacting purposes and a radially inner surface (4) containing a plurality of open cavities (5F) in a form of a pairs of open semi hemispherical configurations with a polyurethane carcass (6) containing sidewall (7) where the polyurethane carcass (6) interlocked with the cured rubber tread (3) by an intrusion of portions (8F) of the polyurethane carcass (6) extending into and taking the shape of tread cavities (5F) to thereby interlock the polyurethane carcass (6) with said cured rubber tread (3).

FIG. 7 illustrates a cross sectional view of a tire mold (10) composed of a top, or outer, section (11), side sections (13A and 13B) together with a mandrel to provide an internal cavity (16). A re-shaped and cured annular rubber tire tread (2) is positioned in the cavity (16) and optionally held against the top, or outer, section (11) by application of a vacuum applied through vacuum lines (12). A liquid polyurethane reaction is to be applied from a pump (not shown) into the mold cavity (16) through conduits (15A and 15B) which are fastened to the side section(s) (13A and 13B) by fastening plates (14A and 14B).

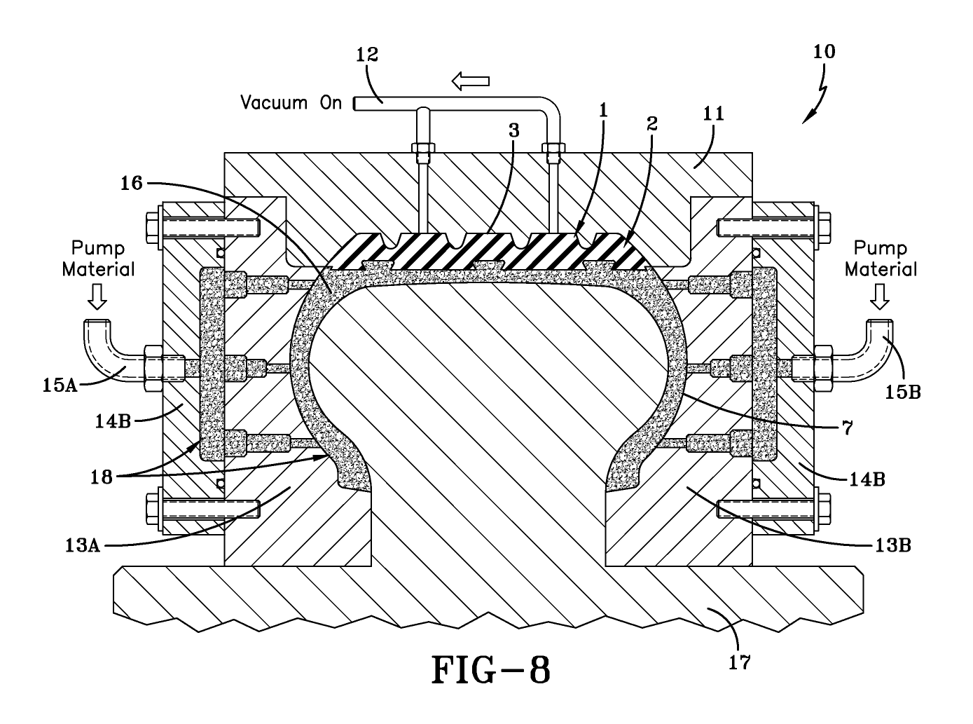

FIG. 8 is an enlarged view of the upper half of the tire mold (10), with the cross-section of the inserted cured rubber tread (2) optionally held by vacuum against the upper tire mold section (11), having its radially outer surface (3) configured with lugs and grooves and its radially inner surface (shown but not numbered) containing a plurality of open trapezoidal shaped cavities (shown but not numbered) (2). A liquid polyurethane reaction mixture (18) is pumped as a “Pump Material” into the mold cavity (16) through conduits (15A and 15B) to fill the mold cavity (16) and the open cavities in the radially inner surface of the cured tire tread (2). The polyurethane reaction is allowed to cure to from a polyurethane tire carcass interlocked with the cured rubber tire tread (2) through its plurality of open cavities.

The practice of the invention is further illustrated by reference to the following example which is intended to be representative rather than restrictive of the scope of the invention. Unless otherwise indicated, any reported parts and percentages are by weight.

### Example

Flat rubber samples were prepared by sulfur curing a rubber composition in a suitable smooth surfaced mold under conditions of elevated temperature and pressure without application of a mold release agent coating to the rubber composition. The rubber composition was a natural cis 1,4-polyisoprene rubber (100 phr) based rubber composition containing conventional rubber compounding ingredients including reinforcing filler as 15 phr of precipitated silica and 22 phr of rubber reinforcing carbon black together with sulfur based cure package, antioxidant(s), zinc oxide, fatty acid, rubber processing oil and resins.

A liquid polyurethane reaction mixture was obtained which was comprised of a prepolymer of diphenylmethane-4,4′-diisocyanate and polyester polyol, with a molar excess of isocyanate groups to hydroxyl groups of the polyester polyol of less than one percent, together with a diamine curative. The prepolymer was melted to form a liquid by slowly heating to about 80° C. The diamine curative to be added to the melted prepolymer (ratio of prepolymer to diamine of about 9.3/1) was comprised of a blend of chemically blocked tris(4,4′-diaminodiphenhlmetnane) sodium chloride in liquid dioctyl adipate plasticizer. At an elevated temperature the diamine becomes unblocked and thereby reactive.

A mold assembly was heated to about 120° C. into which was placed a cured rubber sheet. The liquid polyurethane reaction mixture was cast onto the surface of the cured rubber sheet in the mold and the polyurethane reaction mixture allowed to cure for about 16 to 18 hours at about 120° C. to form a composite composed of a polyurethane layer adhered to the cured rubber sheet.

Control Sample A was prepared as a composite of the polyurethane reaction mixture applied and cured onto the smooth surfaced flat cured rubber sheet to form a composite of polyurethane and cured rubber sheet

Experimental Sample B was prepared in the manner of the Control Sample A except that the cured rubber sheet was presented with mechanically formed open cavities in its surface in a form of a plurality shallow open groove depressions ground across its entire surface to which the polyurethane reaction was applied.

Experimental Sample C was prepared in the manner of Experimental Sample B except that a primer coat was applied to the grooved surface followed by two coats of a polyurethane-to-rubber adhesive applied over the primer coat prior to application of the polyurethane reaction mixture. The primer coat was based upon containing trichloroisocyanuric acid as Chemlock™ as a product of the Lord Corporation. The polyurethane-to-rubber adhesive was ADH 1020™ as a polyurethane-to-rubber adhesive product from Forsch Polymers Corporation reportedly comprised of a mixture of polymers, organic compounds and mineral fillers dissolved in organic solvents.

Adhesion (e.g. bonding strength) of the cured polyurethane to the surface of the cured rubber sheet for the Control Sample A and Experimental Samples B and C was evaluated with an Instron™ test apparatus as a peel test in which the polyurethane layer was pulled away from the surface of the cured rubber sheet at a 90° angle to each other (total angle of 180°). A summary of test results is presented in the following Table 1.

TABLE 1

| | Average Adhesion |
|---|---|
| | (Instron ™ |
| Samples | Peel Test (Newtons)) |
| Control Sample A (cured rubber surface) | 17 |
| Experimental Sample B | 120 |
| (open grooved cured rubber surface) | |
| Experimental Sample C (adhesive over primer | 198 |
| coated open grooved cured rubber surface) | |

From Table 1 it can be seen that providing the cured rubber sheet with the open grooved cavities in the manner of Experimental Sample B resulted in a seven (7) fold increase in adhesion of the polyurethane to the cured open grooved rubber sheet as compared to the non-grooved cured rubber sheet of Control Sample A. This is considered as being satisfactorily predictive of significant adhesion of a cured rubber tire tread to a polyurethane carcass in a manner of interlocking the cured rubber tread with the polyurethane carcass via open cavities in the surface of the cured rubber tread which adjoin the polyurethane carcass.

From Table 1 it can further be seen that providing the cured rubber sheet with a polyurethane-to-rubber adhesive over primer coating of the surface of the cured rubber sheet containing the open groove cavities prior to casting of the polyurethane reaction mixture in manner of Experimental Sample C resulted in an eleven (11) fold increase in adhesion of the polyurethane to the cured open groove-containing rubber sheet as compared to the non-grooved cured rubber sheet of Control Sample A. This is considered as being satisfactorily predictive of significant adhesion of a cured rubber tire tread to a polyurethane carcass in a manner of interlocking, particularly mechano-chemically interlocking, the cured rubber tread with the polyurethane carcass via a protrusion of the polyurethane carcass into open cavities contained in the surface of the cured rubber tread.

While certain representative embodiments and details have been shown for the purpose of illustrating the invention, it will be apparent to those skilled in this art that various changes and modifications may be made therein without departing from the spirit or scope of the invention.

What is claimed is:

1. A tire comprised of a circumferential rubber tread interlocked with a polyurethane carcass.

2. The tire of claim 1 comprised of an annular cured rubber tread and a toroidal polyurethane carcass supporting and interlocked with the cured rubber tread, where the cured rubber tread is configured with open cavities in its radially inner surface and wherein portions of said toroidal polyurethane carcass protrude into and occupy said open cavities of said rubber tread to thereby mechanically and/or mechano-chemically interlock said polyurethane carcass to said rubber tread.

3. The tire of claim 1 the surfaces of said open cavities of said cured rubber tread contain at least one of primer and adhesive coating.

4. The tire of claim 1 wherein the surfaces of the said open cavities of said cured rubber tread contains a polyurethane-to-elastomer bonding adhesive coating.

5. The tire of claim 1 wherein the surfaces of the said open cavities of said cured rubber tread contains a polyurethane-to-elastomer bonding adhesive over a primer coating.

6. The tire of claim 1 wherein the open cavities in the surface of the cured rubber tread is composed of various configurations comprised of at least one of trapezoidal, prismatic, truncated prismatic, cubical, polygonal, semi-hemispherical rectangular configurations, grooves comprised of at least one of directionally oriented and randomly positioned grooves.

7. The tire of claim 1 wherein the polyurethane carcass contains an internal load bearing support.

8. The tire of claim 1 wherein the polyurethane carcass contains an internal load bearing support comprised of interwoven wire spring structure.

9. The tire of claim 1 wherein at least one of the polyurethane carcass and cured rubber tread contains an internal load bearing support comprised of a circumferential belt.

10. The tire of claim 9 wherein the circumferential belt contained in the cured rubber tread is comprised of a woven belt and the circumferential belt contained in the polyurethane carcass is comprised of a woven belt or comprised of a wire spring structured belt.

11. The tire of claim 1 wherein the liquid polyurethane reaction mixture is comprised of:
(A) at least one hydroxyl terminated polymeric polyol and polyisocyanate, or
(B) a prepolymer of at least one hydroxyl terminated polymeric polyol and polyisocyanate combined with a diamine curative or hydroxyl terminated curative.

12. The tire of claim 1 wherein the polyurethane carcass contains particulate reinforcement comprised of at least one of carbon black, clay, silica, volcanic ash and cellulosic fillers.

13. A method of preparing a tire having a circumferential rubber tread interlocked with a polyurethane carcass which comprises:
(A) inserting a cured annular rubber tread into a toroidal tire mold cavity with the radially outer surface of the cured rubber tread fitted against an internal peripheral surface of the tire mold cavity where the radially inner surface of said cured rubber tread contains a plurality of open cavities on its radially inner surface;
(B) Introducing a liquid polyurethane reaction mixture into the tire mold cavity to fill the mold cavity and open cavities of said annular cured rubber tread and thereafter allowing the polyurethane reaction mixture to react and form a solid polyurethane toroidal tire carcass interlocked with the open cavities of said cured rubber tread.

14. The method of claim 13 wherein portions of said toroidal polyurethane carcass protrude into and occupy said open cavities of said rubber tread to thereby mechanically and/or mechano-chemically interlock said polyurethane carcass to said rubber tread.

15. The method of claim 13 wherein the surfaces of said open cavities of said cured rubber tread contain at least one of primer and adhesive coating.

16. The method of claim 13 wherein the surfaces of the open cavities of said cured rubber tread contains a polyurethane-to-elastomer bonding adhesive over a primer coating.

17. The method of claim 13 wherein the open cavities contained in the surface of the cured rubber tread are composed of various configurations comprised of at least one of trapezoidal, prismatic, truncated prismatic, cubical, polygonal, semi-hemispherical rectangular and grooves comprised of at least one of directionally oriented and randomly oriented grooves.

18. The method of claim 13 wherein the surface of said cured rubber tread contains a polysiloxane based mold release agent which is removed by one or more of organic solvent cleaning, abrading away a portion of the cured rubber surface prior to application of said polyurethane reaction mixture.

19. The method of claim 13 wherein the surface of the cured rubber tread is activated by at least one of laser and plasma treatment prior to application of said polyurethane reaction mixture.

20. The tire of claim 1 wherein the polyurethane carcass contains at least one circumferential belt embedded within the polyurethane carcass comprised of at least one of a woven belt or interwoven wire spring structured belt.
